(19) United States
(12) Patent Application Publication
(10) Pub. No.: US 2011/0163078 A1
(43) Pub. Date: Jul. 7, 2011

(54) DEVICE AND METHOD FOR MACHINING WORKPIECE WITH A LASER BEAM

(75) Inventors: Takeshi FUKUSHIMA, Hekinan-shi (JP); Keiji SAKAI, Kariya-shi (JP); Hiroyuki OOTANI, Anjo-shi (JP)

(73) Assignee: DENSO CORPORATION, KARIYA-CITY (JP)

(21) Appl. No.: 12/978,988

(22) Filed: Dec. 27, 2010

(30) Foreign Application Priority Data
Jan. 6, 2010 (JP) 2010-001338

(51) Int. Cl. B23K 26/38

(52) U.S. Cl. 219/121.71; 219/121.7

(57) ABSTRACT

A laser machining device machines a workpiece having a machining portion where a hole is machined and a non-machining portion positioned on an extension of the hole. The laser machining device includes a nozzle that jets a column of liquid towards the hole of the machining portion and a laser head that introduces a laser beam into the column of liquid jetted towards the hole. The workpiece is held by a holding member. A laser beam blocking member is disposed in the non-machining portion. The laser beam blocking member blocks the laser beam that passes through the hole. Furthermore, a discharge path that discharges the liquid reaching the hole is provided in the laser beam blocking member.

### CROSS-REFERENCE TO RELATED APPLICATION

This application is related to Japanese Patent Application No. 2010-001338 filed on Jan. 6, 2010, the contents of which are hereby incorporated by reference.

### BACKGROUND

1. Technical Field

The present invention relates to a device and method for machining a workpiece using a laser beam. In particular, the present invention relates to a device and method for machining a workpiece by introducing a laser beam into a liquid column, and irradiating the workpiece with the liquid column and the laser beam using the liquid column as a guide, such as water-jet laser machining.

2. Description of the Related Art

In recent years, the demand for precision and operating efficiency has increased in the machining industry, such as hole drilling. For example, in the field of hole drilling, a technique is required for drilling fine holes. A machining method referred to as water-jet laser machining is used.

Japanese Patent No. 3680864 describes an example of a device used to perform water-jet laser machining. In this conventional device, a water column (water jet) is formed by high-pressure water being jetted from a nozzle towards a machining surface. A laser beam is then introduced into the water column. As a result, the water column serves as a guide for the laser beam, much like optical fiber. The water-jet laser formed by the water column and the laser beam reaches the workpiece. As a result, the workpiece is machined by the water jet and the laser beam.

In laser machining such as this, namely in so-called water-jet laser machining, a process in which the workpiece is moved in relation to the water-jet laser is repeated a plurality of times. As a result, a desired shape can be machined. Here, the desired shape is a through-hole of φ0.3 mm or less. The smallest diameter of the through-hole is generally determined by the diameter of the water column to be jetted.

Compared to air laser (dry laser) cutting in which a water jet is not used, water-jet laser machining can reduce heat-affected zones on a machining surface and achieve excellent machining quality.

On the other hand, Japanese Patent Laid-open Publication No. 2008-55477 describes a method for air laser cutting. In the method, first, a workpiece is irradiated with a nanosecond laser beam, and a prepared hole is formed. Then, the inner wall of the prepared hole is irradiated with a picosecond laser beam and finished by being smoothened. As a result, the method seeks to enable fine-hole drilling to be performed quickly and with high precision.

The inventors of the present invention have discussed application of the above-described water-jet laser machining to machining of a spray hole (fine hole) of a fuel injection valve (injector) used in a fuel injection device of an internal combustion engine. In other words, in recent years, restrictions on exhaust gas emitted from internal combustion engines have become increasingly stricter for the purpose of environmental improvement. The discussed application is in response to these restrictions. As a result of the stricter restrictions, higher precision is strongly required in the control of injection amount in the fuel injection device of an internal combustion engine. Therefore, machining quality of the spray hole in the fuel injection valve is required to be improved. As a means for achieving this improvement, water-jet laser machining is considered promising.

However, the spray hole portion of the fuel injection valve is configured by an open-drum shaped (i.e., a cylindrical shape of which one end is opened and the other end is closed) component. The spray hole is formed at an angle to the open-drum shaped component. Therefore, when the spray hole is machined, a laser beam that has passed through the spray hole hits an inner wall portion of the open-drum shaped component. A problem occurs in that the inner wall portion that is a non-machining portion is also machined.

As a countermeasure, placement of a laser beam blocking member in the inner wall portion that is the non-machined portion is considered. However, when the laser beam blocking component is placed, obstruction of the emission of the water column by the laser beam blocking component is also required to be taken into consideration.

In other words, in water-jet laser machining, the water column serves to guide the laser beam. Therefore, when the emission of the water column is obstructed and water remains in the machining portion, the laser beam cannot be successfully guided. As a result, machining is halted. Alternatively, even if machining is performed, machining efficiency significantly decreases.

### SUMMARY

An embodiment provides an apparatus and a method to prevent machining of a non-machining portion, in addition to improving machining efficiency, when a workpiece is machined in which the non-machining portion is positioned on an extension of a hole to be machined.

To achieve the above-described object, according to an aspect of the invention, a laser machining device is provided that machines a workpiece including a first portion through which a hole is to be machined and a second portion having a surface which should be prevented from being machined, the surface being positioned obliquely to a direction perpendicular to a cross-section of the hole. The laser machining device includes: a nozzle that jets a column of liquid towards the hole of the first portion; a laser head that introduces a laser beam into the column of liquid jetted towards the hole; a holding member that holds the workpiece and a laser beam blocking member that is disposed in the second portion and blocks the laser beam that passes through the hole. A discharge path that discharges the liquid reaching the hole is provided in the laser beam blocking member.

The laser beam blocking member is disposed such as oppose or cover the second portion. Therefore, the laser beam that passes through the hole collides with the laser beam blocking member. As a result, machining of the second portion by the laser beam is prevented.

Furthermore, the discharge path that discharges the liquid reaching the hole is provided in the laser beam blocking member. Therefore, the liquid is discharged through the discharge path in the liquid beam blocking member without remaining in the first portion. As a result, decrease in machining efficiency caused by the liquid remaining in the first portion can be prevented. Machining efficiency can be enhanced.

In a preferred example, a cross-sectional area of the discharge path is greater than an exit area of the nozzle. Therefore, the liquid can be effectively discharged through the discharge path. Machining efficiency can be further enhanced.

In another example, the holding member is configured to be capable of adjusting the angle of the workpiece and the laser beam blocking member in relation to a jetting direction of the liquid. Therefore, the workpiece can be machined even when the hole to be machined is at an angle. As a result, the present invention can be favorably applied, for example, to a hole drilling machine for machining a spray hole of a fuel injection valve.

On the other hand, according to another aspect of the present invention, a laser machining method is provided for machining a workpiece including a first portion through which a hole is to be machined and a second portion having a surface which should be prevented from being machined, the surface being positioned to be crossed with a longitudinal direction perpendicular to a cross-section of the hole, the hole being machined by using a column of liquid and a laser beam introduced into the column of liquid. In the laser machining method, a laser beam blocking member provided with a discharge path that discharges the liquid reaching the hole is disposed in the second portion. The column of liquid is jetted towards the hole of the first portion and the laser beam is introduced into the column of liquid. As a result, effects equivalent to the effects achieved according to the above-described aspect can be achieved.

In a preferred example of the laser machining method, the workpiece and the laser beam blocking member are swung in relation to a jetting direction of the liquid when the column of liquid is jetted from the nozzle and the laser beam is irradiated from the laser head. As a result, the hole is machined into a slit shape. A travel speed (relative speed) of the laser beam is slower at the depth of the workpiece compared to that at the surface of the workpiece. Therefore, machining can be successfully performed even when laser power is attenuated (low power value). Furthermore, multiple laser beams overlap in the depth of the workpiece, thereby contributing to improvement in machining surface.

### BRIEF DESCRIPTION OF THE DRAWINGS

In the accompanying drawings:

FIG. 1 is a perspective view of a rough overall configuration of a hole drilling machine according to a first embodiment;

FIG. 2 is a schematic diagram of a finish-machining device and a holding member according to the first embodiment of the present invention;

FIG. 3A to FIG. 3D are three side views and a perspective view of the holding member according to the first embodiment, showing an example of angle adjustment;

FIG. 4A to FIG. 4D are three side views and a perspective view of the holding member according to the first embodiment, showing another example of angle adjustment;

FIG. 5A is a planar view of a workpiece according to the first embodiment;

FIG. 5B is a cross-sectional view taken from line A-A of FIG. 5A;

FIG. 5C is an explanatory diagram showing a machining portion and a non-machining portion based on the cross-sectional view of the FIG. 5B;

FIG. 6 is a flowchart of a hole machining process according to the first embodiment;

FIG. 7A and FIG. 7B are schematic views describing a hole machining procedure according to the first embodiment;

FIG. 8A and FIG. 8B are schematic views describing a machining process for a hole according to a second embodiment of the present invention;

FIG. 9A and FIG. 9B are a planar view and a cross-sectional view of a workpiece respectively, according to a third embodiment of the present invention;

FIG. 10 is a schematic view of a finish-machining device and a holding member according to the third embodiment;

FIG. 11 is a flowchart of a hole machining process according to the third embodiment; and

FIG. 12A and 12B are a schematic view describing a hole machining procedure according to the third embodiment.

### DETAILED DESCRIPTION OF THE PREFERRED EMBODIMENTS

The preferred embodiments of “a device and a method for machining a workpiece using a laser beam”, namely a laser machining device and a laser machining method, of the present invention will be described with reference to the accompanying drawings.

### First Embodiment

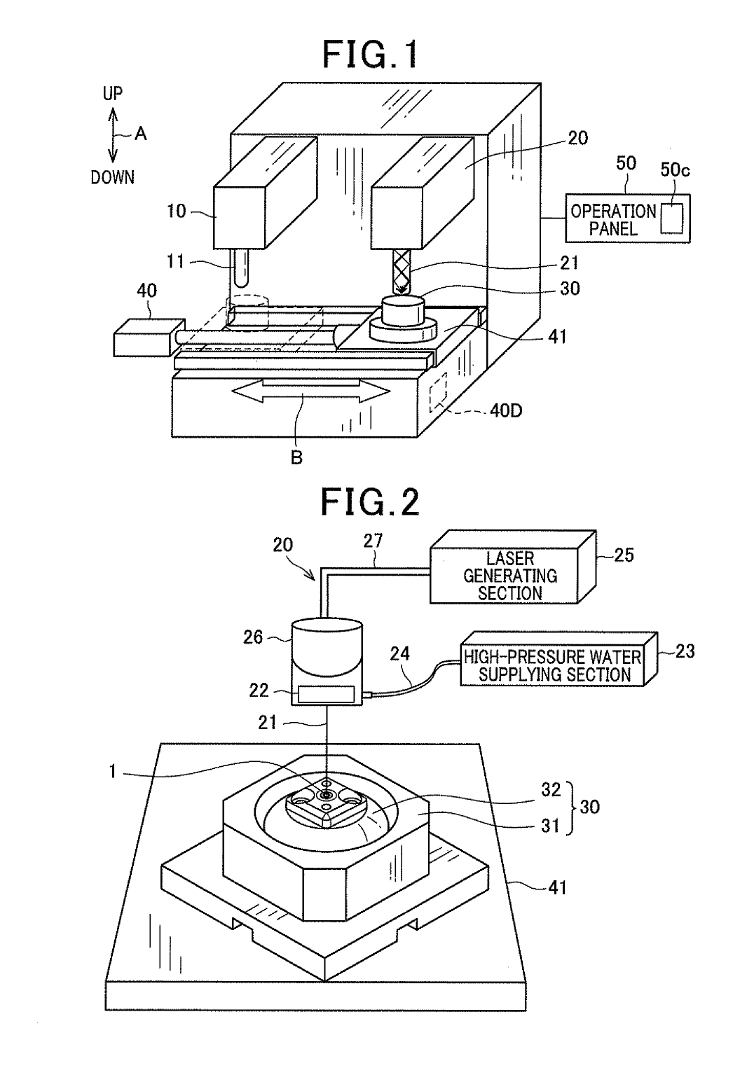

First, a first embodiment will be described with reference to FIG. 1 to FIG. 7. According to the first embodiment, the laser machining device and the laser machining method of the present invention are applied to a hole drilling machine for machining a plurality of spray holes in a component (workpiece) configuring a tip of a fuel injection valve (injector) installed in a vehicle.

The spray hole of the fuel injection valve is a fine hole that is less than φ=0.3 mm and is at an angle described later. Circularity, cylindricity, and the like are required to be extremely accurate. The angle refers to an angle in relative to a direction perpendicular to the surface on which the spray hole is formed and is about 80° or less.

FIG. 1 is a perspective view of a rough overall configuration of the hole drilling machine. An up/down arrow A in FIG. 1 indicates the up/down direction of the hole drilling machine in a setup state.

The hole drilling machine includes a rough machining device 10 that roughly machines the fine hole in a workpiece 1 (see FIG. 2) and a finish-machining device 20 that finish-machines the roughly machined fine hole. The rough machining device 10 roughly machines the fine hole in the workpiece 1 by irradiating an air laser 11 (a yttrium-aluminum-garnet [YAG] laser in the present example) towards the workpiece from an air laser device in the rough machining device 10. The finish-machining device 20 finish-machines the roughly machined fine hole in the workpiece 1 using a water-jet laser 21 irradiated from the finish-machining device 20.

The hole drilling machine also includes a holding member 30 that holds the workpiece 1, a conveying device 40, and an operating panel 50 used to operate the rough machining device 10, the finish-machining device 20, and the conveying device 40. The conveying device 40 carries the holding member 30 to-and-from between the rough machining device 10 and the finish-machining device 20 as indicated by an arrow B in FIG. 1. The conveying device is driven by a moving mechanism 40D such as motor or the like. The operating panel 50 includes a computer device (50C) that receives operating information from an operator and drives the hole drilling machine in adherence to a predetermined procedure. Therefore, machining processes described hereafter are managed by the computer device that receives instructions from the operator.

FIG. 2 is a schematic diagram of the finish-machining device 20 and the holding member 30. The finish-machining device 20 includes a nozzle 22, a high-pressure water supplying section 23, a piping section 24, a laser generating section 25, a laser head 26, and an optical fiber section 27.

The nozzle 22 jets high-pressure water that forms a water column (water jet) serving as a liquid column (liquid beam). The high-pressure water supplying section 23 supplies high-pressure water to the nozzle 22. The piping section 24 connects the nozzle 22 and the high-pressure water supplying section 23.

The laser generating section 25 generates a laser beam (a green laser device is used in the present example). The laser head 26 narrows the diameter of the laser beam generated by the laser generating section 25 to a desired diameter and introduces the laser beam into the interior of the water column. The optical fiber section 27 connects the laser generating section 25 and the laser head 26.

The water-jet laser 21 is formed by the water column jetted from the nozzle 22 and the laser beam irradiated from the laser head 26. The water column of the water-jet laser 21 is not limited to pure water and may be a liquid other than water.

The holding member 30 that holds the workpiece 1 is configured to be capable of adjusting the angle of the workpiece 1 in the irradiation direction of the water-jet laser 21 or, in other words, the jetting direction of the water column (specifically, the up/down direction A in FIG. 1). Specifically, the holding member 30 includes a base section 31 placed on a seat 41 of the conveying device 40 and a movable section 32 on which the workpiece 1 is set. The holding member 30 is configured such that the base section 31 and the movable section 32 are in contact with each other on a spherical surface.

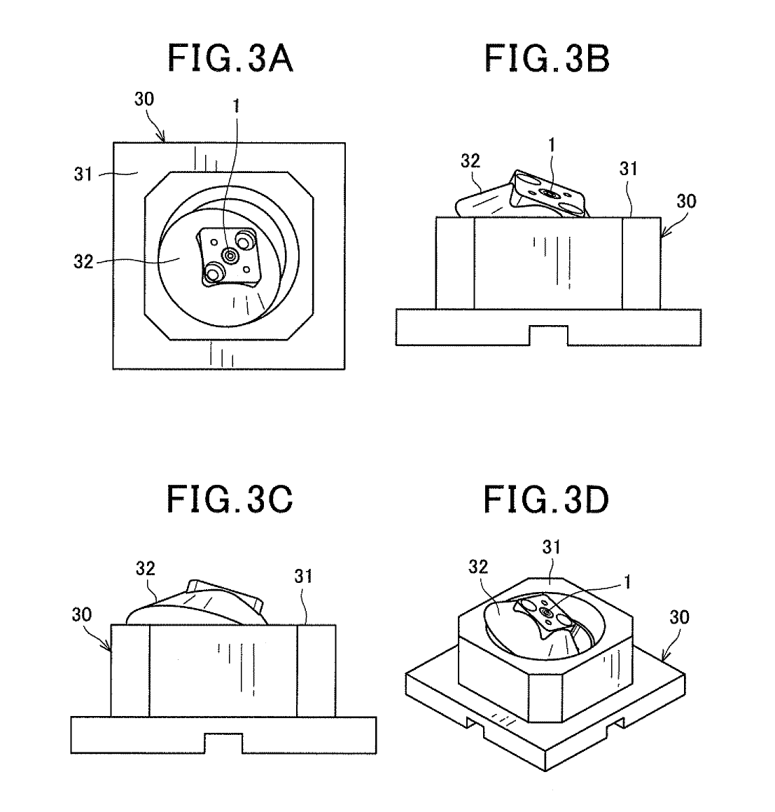

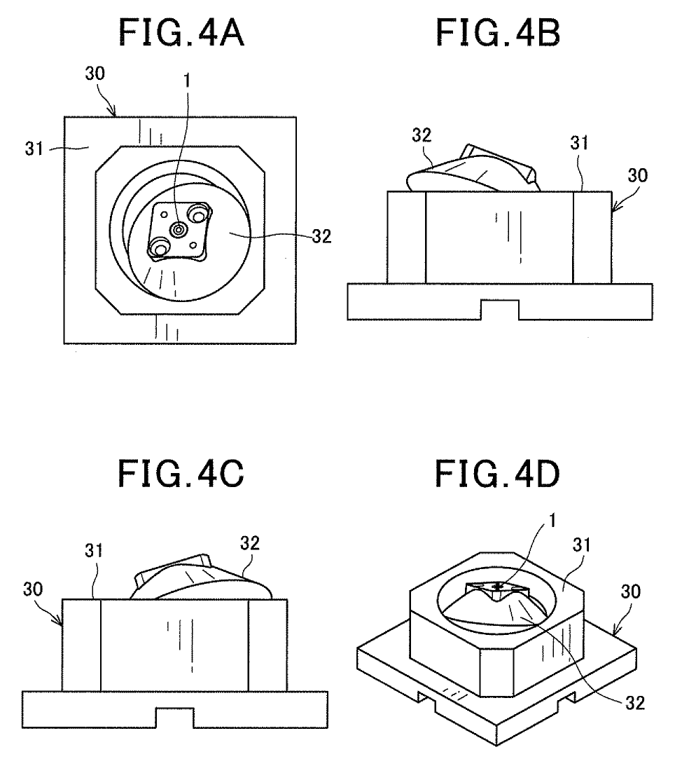

FIG. 3A to FIG. 3D show an example of when the holding member 30 adjusts the angle of the workpiece 1. FIG. 4A to FIG. 4D show another example of when the holding member 30 adjusts the angle of the workpiece 1. Among these drawings, FIG. 3A to FIG. 3C and FIG. 4A to FIG. 4C are three side views of the holding member 30 in each example. FIG. 3D and FIG. 4D are perspective views of the holding member 30 in each example.

The movable section 32 can be driven by a driving means, such as an actuator, or manually operated.

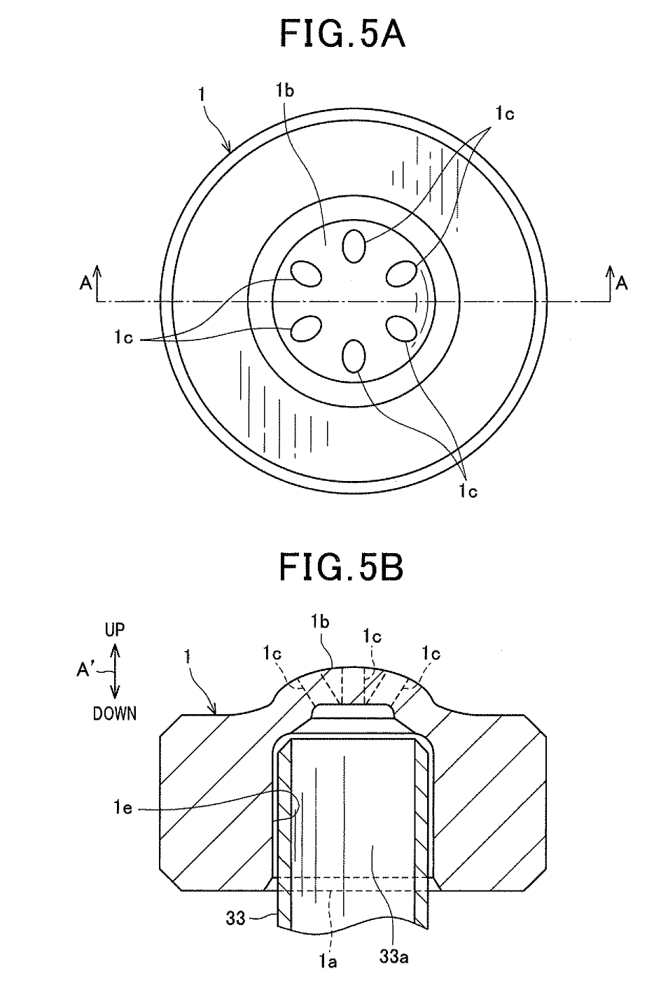

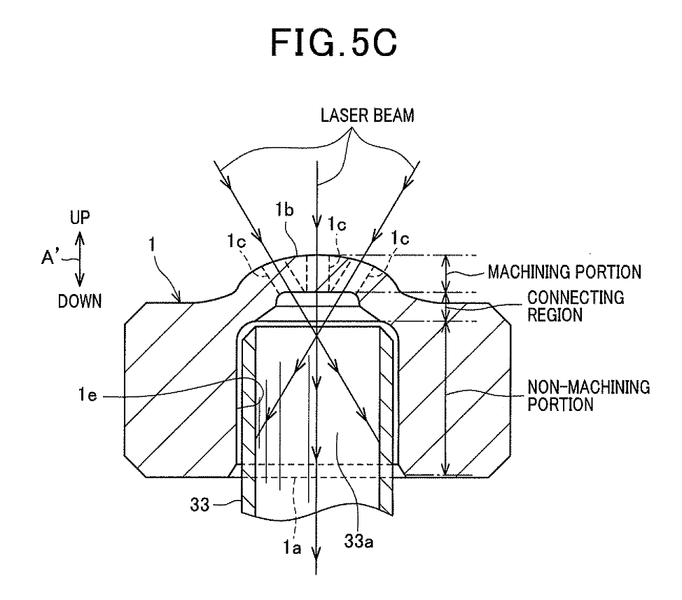

FIG. 5A and FIG. 5B are a planar view and a cross-sectional view of the workpiece 1. An up/down arrow in FIG. 5B indicates a basic up/down direction A′ of the holding member 30 in a setup state.

The workpiece 1 has an open-drum shape. Specifically, the workpiece 1 has an opening section 1a on one end side in the axial direction (up/down direction A′) and a sealed section 1b on the other end side in the axial direction. As a result, a bottomed-cylindrical shape with a bore is formed. When the workpiece 1 is set in the movable section 32 of the holding member 30, the opening section 1a faces the holding member 30 side (specifically, the downward side).

In the sealed section 1b, a plurality (six in the present example) of fine holes (spray holes) 1c are machined by the hole drilling machine. The holes 1c are formed in differing positions and at differing angles. According to the first embodiment, the holes 1c are round holes. The shape of the cross-section perpendicular to the axial direction is circular.

When the holes is are machined by the hole drilling machine, a laser beam blocking member 33 is inserted into the bore of the workpiece 1 from the opening section 1a of the workpiece 1. The laser beam blocking member 33 is formed into a circular cylindrical shape having an opening in both ends in the axial direction, using a material with a high heat-resistance temperature and a high laser beam reflectance (such as copper, Teflon [registered trademark], silica, or sapphire). In other words, as shown in FIG. 5B, the laser beam blocking member 33 has an internal space 33a of which both ends are open.

The cross-sectional area perpendicular to the axial direction A′ of the internal space 33a of the laser beam blocking member 33 is greater than the exit area of the nozzle 22 or, in other words, the cross-sectional area of the water column of the water-jet laser 21.

The laser beam blocking member 33 can be set in the movable section 32 of the holding member 30. The laser beam blocking member 33 can be in contact with the inner wall of the workpiece 1 or at a slight distance from the inner wall of the workpiece 1 in a state in which the laser beam blocking member 33 is inserted into the bore of the workpiece 1.

FIG. 5C is an explanatory diagram showing machining and non-machining portion based on the cross-sectional view of the FIG. 5B. As shown in FIG. 5C, respective laser beams of which incident angles are different pass through machining portion at which respective holes is are machined. Then, the laser beams are blocked by the laser beam blocking member 33 in the non-machining portion. Note that the laser beams passing through the machining portion arrives at the non-machining portion via a connecting region. The machining portion corresponds to a first portion and the non-machining portion corresponds to a second portion.

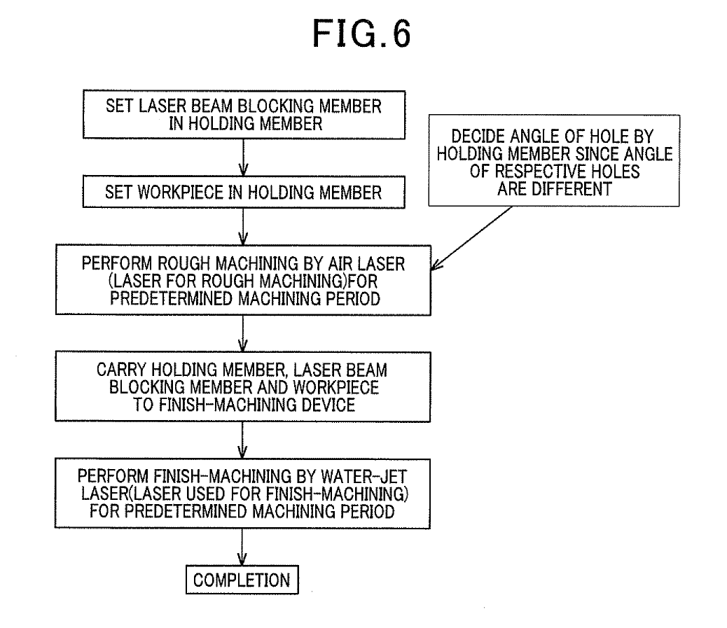

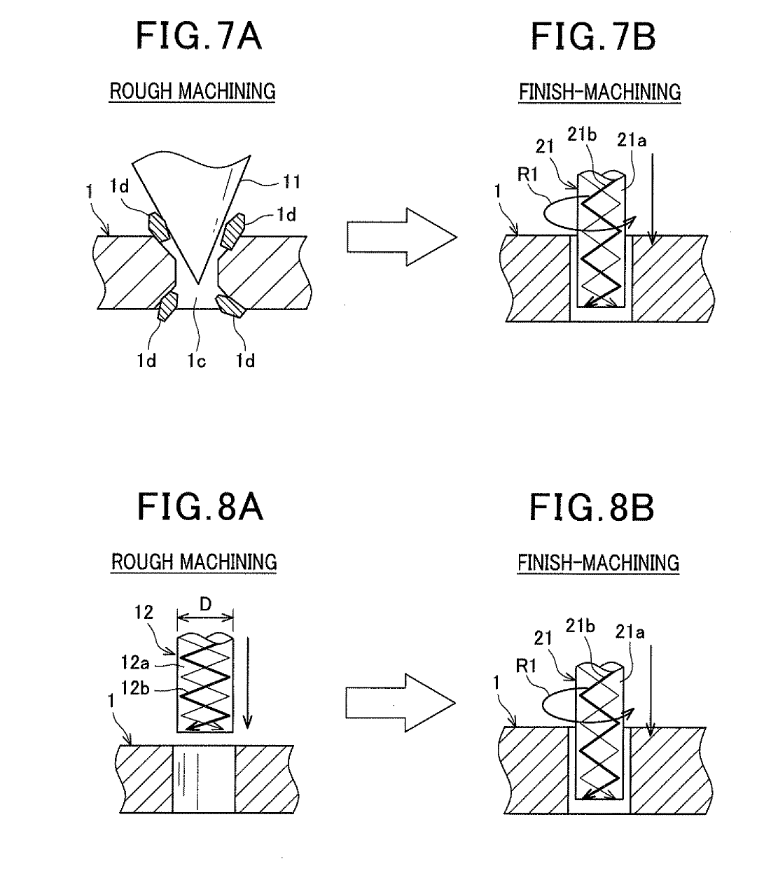

Next, a machining process for the hole 1c using the hole drilling machine configured as described above will be described. FIG. 6 is a flowchart of the machining process for the hole 1c. FIG. 7A and FIG. 7B are schematic diagrams describing the machining procedure for the hole 1C.

First, in a state in which the seat 41 of the conveying device 40 and the holding member 30 are in a predetermined position directly below the rough machining device 10, the laser beam blocking member 33 is set in the holding member 30. Next, the workpiece 1 is set in the holding member 30. At this time, the laser beam blocking member 33 is inserted into the bore of the workpiece 1.

Next, as shown in FIG. 7A, the air laser 11 that is a laser for rough machining is irradiated towards the workpiece 1 from the rough machining device 10. The plurality of holes 1c are machined one by one in the workpiece 1. At this time, the angle of each hole is differs. Therefore, the angle of each hole is is decided by the holding member 30 adjusting the angle of the workpiece 1.

Due to the characteristics of the air laser 11, the roughly machined hole is has a tapered shape rather than a straight shape. The surface roughness is large and the effect of heat is significant. Reference number 1d shown in FIG. 7A indicates debris formed by rough machining.

Next, the conveying device 40 carries the holding member 30 to the finish-machining device 20 with the laser beam blocking member 33 and the workpiece 1. The holding member 30 is positioned in a predetermined position directly below the finish-machining device 20.

Then, as shown in FIG. 7B, the water-jet laser 21, specifically a water column 21a and a laser beam 21b, are irradiated towards the workpiece 1 from the finish-machining device 20. As a result, the roughly machined holes is are finish-machined one by one. At this time, the holding member 30 adjusts the angle of the workpiece 1 and matches the direction of the hole 1c with the irradiation direction of the water-jet laser 21.

During the finish-machining, the hole is is enlarged while rotating the holding member 30 as indicated by an arrow R1 in FIG. 7B. The holding member 30 is rotated by a rotating mechanism (not shown).

As FIG. 7B clearly shows, once the hole 1c has passed through the workpiece 1, machining using the water-jet laser 21 can be performed because collision of the water column 21a is small. The finish-machined hole 1c is formed having a straight shape, with small surface roughness, and little effect from heat due to the characteristics of the water-jet laser 21. Machining of the plurality of holes 1c in the workpiece 1 is completed by the above-described process.

According to the first embodiment, rough machining and finish-machining are performed with the laser beam blocking member 33 inserted into the workpiece 1. Therefore, during rough machining and finish-machining, the laser beams 11 and 21b passing through the hole is collide with the laser beam blocking member 33 and are blocked. As a result, machining of a non-machining portion of the workpiece 1, namely an inner wall section le (see FIG. 5B) positioned on an extension of the hole 1c (to be machined), by the laser beams 11 and 21b can be prevented.

Furthermore, the laser beam blocking member 33 opposing the inner wall section le is formed into a cylindrical shape. Therefore, during finish-machining, the water column 21a is discharged outside through the internal space 33a of the laser beam blocking member 33, without remaining in the machining portion. In other words, the internal space 33a of the laser beam blocking member 33 serves as a discharge path for discharging the water column 21a that reaches the hole 1c.

Therefore, a decrease in machining efficiency caused by the water column 21a remaining in the machining portion can be prevented. Machining efficiency can be enhanced.

### Second Embodiment

A second embodiment will be described with reference to FIG. 8A and FIG. 8B. According to the second and subsequent embodiments, constituent elements that are the same as or similar to those according to the above-described first embodiment are given the same reference numbers. Descriptions thereof are omitted or simplified.

According to the above-described first embodiment, the rough machining device 10 roughly machines the hole 1c by irradiating the air laser 11 towards the workpiece 1. However, according to the second embodiment, as shown in FIG. 8A and FIG. 8B, the rough machining device 10 is configured to be capable of emitting a water-jet laser 12. In other words, the hole 1c is roughly machined by the water-jet laser 12.

A diameter (namely the diameter of a water column 12a) D of the water-jet laser 12 irradiated from the rough machining device 10 is larger than the diameter of the water-jet laser 21 from the finish-machining device 20. In other words, when the diameter D of the water-jet laser 12 for rough machining is small, its laser power is also small. When the laser power is less than a required value, the water-jet laser 12 does not pass through the workpiece 1. Therefore, the laser power is increased by the diameter D of the water-jet laser 12 being increased, thereby allowing the water-jet laser 12 to pass through the workpiece 1.

For example, when a YAG laser is used as a laser beam 12b of the water-jet laser 12, a workpiece having a thickness t of 0.3 mm can be penetrated when the diameter D of the water-jet laser 12 is 100 μm. A workpiece having a thickness of 0.1 mm can be penetrated when the diameter D of the water-jet laser 12 is 50 μm.

On the other hand, machining precision of the hole is machined by a water-jet laser 12 having a large diameter is generally poorer regarding circularity, cylindricity, and the like. Therefore, the hole 1c is finish-machined by the water-jet laser 21 having a small diameter of the finish-machining device 20. As a result, machining precision regarding circularity, cylindricity, and the like can be ensured.

When the required machining precision is relatively low, a single-operation finish-machining using only the water-jet laser 12 with the large diameter can be performed.

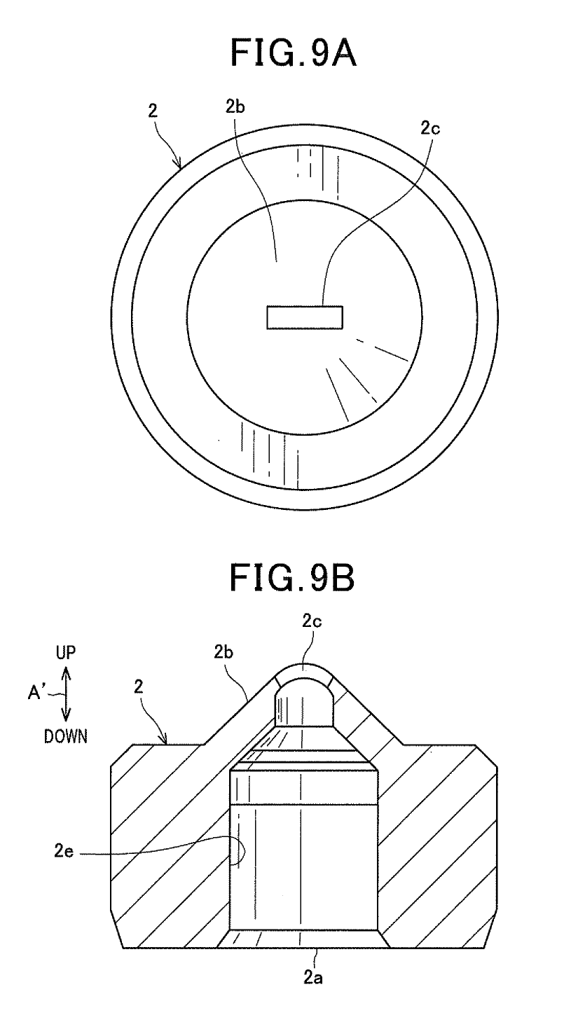

A third embodiment will be described with reference to FIG. 9A and FIG. 9B to FIG. 11.

According to the above-described first embodiment, a circular-shaped hole is is machined in the workpiece 1. However, according to the third embodiment, a slit-shaped hole 2c is machined in a workpiece 2.

FIG. 9A and FIG. 9B are a planar view and a cross-sectional view of the workpiece 2. An up/down arrow in FIG. 9B indicates a basic up/down direction A′ in a state in which the workpiece 2 is set in a holding member 60.

The workpiece 2 has an open-drum shape (i.e., a cylindrical shape of which one end is opened and the other end is closed). An opening section 2a faces downward during machining of the hole 2c. The slit-shaped hole 2c is machined in a sealed section 2b by the hole drilling machine.

When the hole drilling machine machines the hole 2c, the laser beam blocking member 33 is inserted into the workpiece 2 from the opening section 2a of the workpiece 2 (not shown). In other words, the laser beam blocking member 33 is disposed in an inner wall section 2e that is the machining area of the workpiece 2.

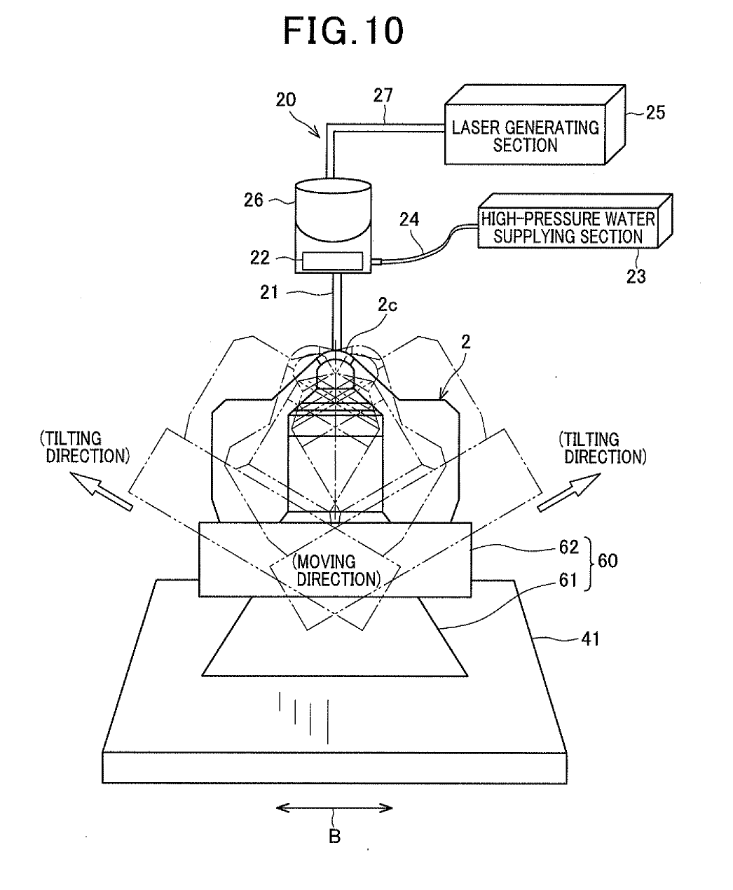

FIG. 10 is a schematic diagram of the holding member 60 holding the workpiece 2 and the like. In FIG. 10, the laser beam blocking member 33 and cross-sectional shading are omitted for convenience.

The holding member 60 has a tilting mechanism for tilting the workpiece 20 in relation to the irradiation direction of the water-jet laser 21 (specifically, the up/down direction A′). Specifically, the holding member 60 includes a base section 61 placed on the seat 41 of the conveying device 40 and a movable section 62 on which the workpiece 2 is set. The movable section 62 is configured such as to swing in a predetermined direction (left/right direction B in FIG. 10) in relation to the base section 61. The movable section 62 is driven by a driving means, such as an actuator.

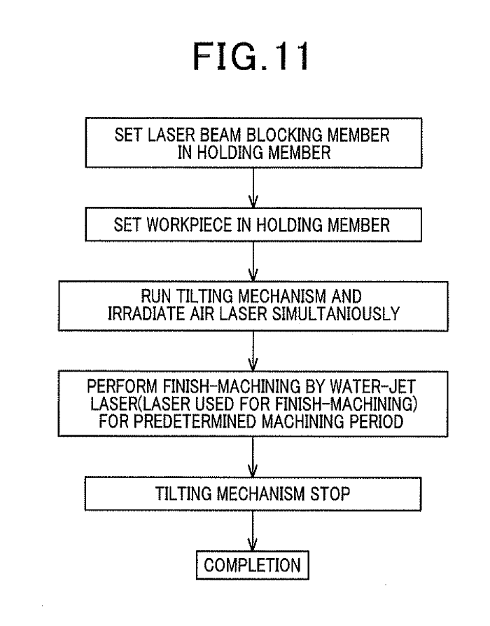

FIG. 11 is a flowchart of a machining process for the slit hole 2c. First, in a state in which the seat 41 of the conveying device 40 and the holding member 60 are in a predetermined position directly below the rough machining device 10, the laser beam blocking member 33 is set in the holding member 60. Next, the workpiece 2 is set in the holding member 60. At this time, the laser beam blocking member 33 is inserted into the bore of the workpiece 2.

Next, the tilting mechanism of the holding member 60 is operated and the workpiece 2 is tilted (swung). In addition, the air laser 11 that is the laser for rough machining is irradiated towards the workpiece 2 from the rough machining device 10. The slit-shaped hole 2c is roughly machined in the workpiece 2.

Next, the conveying device 40 carries the holding member 60 towards the finish-machining device 20 side with the laser beam blocking member 33 and the workpiece 2. The conveying device 40 places the holding member 60, the laser beam blocking member 33, and the workpiece 2 in a predetermined position directly below the finish-machining device 20.

Then, the water-jet laser 21, specifically the water column 21a and the laser beam 21b, is irradiated towards the workpiece 2 from the finish-machining device 20. The roughly machined slit hole 2c is finish-machined. At this time, the slit hole 2c is enlarged while the holding member 60 tilts (swings) the workpiece 2 and the holding member 60 is moved horizontally. The holding member 60 is moved horizontally by the moving mechanism 40D. Machining of the slit hole 2c in the workpiece 2 is completed by the above-described process.

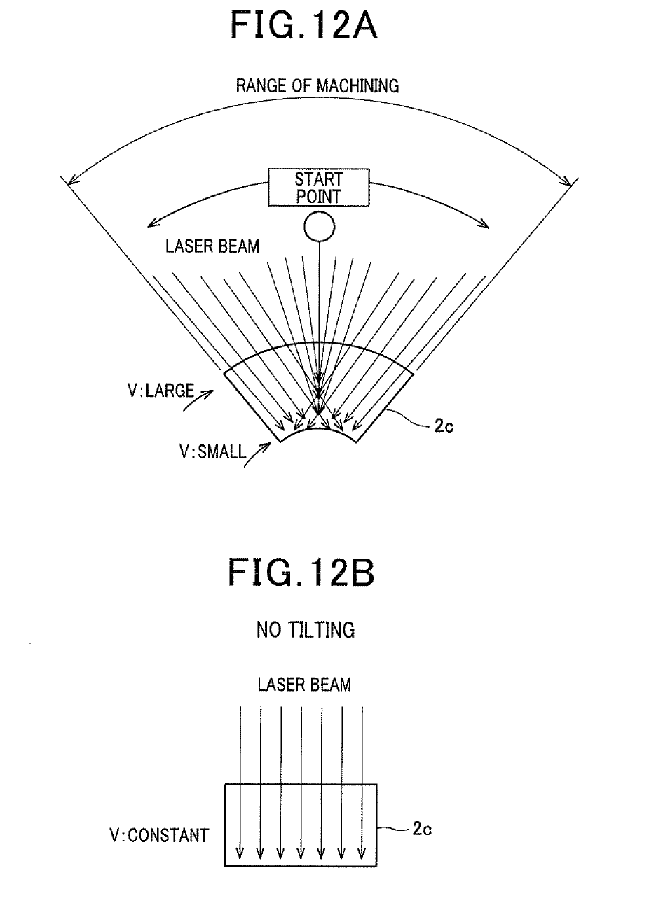

FIG. 12A is a schematic view describing a machining procedure for the slit hole 2c according to the third embodiment. FIG. 12B is a schematic view describing a machining procedure for the slit hole 2c when the slit hole 2c is machined only by parallel movement in the horizontal direction, without the workpiece 2 being tilted.

Laser power generally attenuates from the surface of the workpiece 2 towards the depth of the workpiece 2. Therefore, even when the input value is appropriate, the laser power value during actual machining becomes smaller at the depth of the workpiece 2 compared to that at the surface of the workpiece 2 (in other words, a following relationship is established regarding laser power: laser power at surface>laser power at depth).

Specifically, when the slit hole 2c is machined only by parallel movement in the horizontal direction, without the workpiece being tilted, as shown in FIG. 12B, a laser travel speed (relative speed) V is the same at the surface and at the depth of the workpiece 2.

In other words, regardless of the attenuation of laser power near the depth of the workpiece 2, the laser travel speed V is the same as that at the surface of the workpiece 2. Therefore, machining capability is not maintained near the depth of the workpiece 2, and surface roughness deteriorates (surface becomes rough).

Meanwhile, when the slit hole 2c is machined by the workpiece 2 being tilted as shown in FIG. 12A, the laser travel speed V becomes slower (smaller) at the depth of the workpiece 2, compared to that at the surface of the workpiece 2. Therefore, even when the laser power is attenuated (low power value), machining can be successfully performed. Furthermore, as FIG. 12A clearly shows, multiple laser beams overlap in the depth of the workpiece 2, contributing to improved quality of the machining surface.

### Other Embodiments

According to each of the above-described embodiments, the laser machining device and the laser machining method of the present invention is applied to the machining of a spray hole in a fuel injection valve. However, the present invention is not limited thereto. The present invention can be widely applied to, for example, a mist spray hole of a micro-mist generator or a spray hole of a humidifier.

According to each of the above-described embodiments, the shape of the laser beam blocking member 33 is a circular cylinder. However, the shape is not limited thereto. Other various shapes can be used as long as the shape allows the laser beam passing through the hole to be blocked and has a discharge path for discharging the water column that reaches the hole.

What is claimed is:

1. A laser machining device that machines a workpiece including a first portion through which a hole is to be machined and a second portion having a surface which should be prevented from being machined, the surface being positioned obliquely to a direction perpendicular to a cross-section of the hole, the laser machining device comprising:
a nozzle that jets a column of liquid towards the hole of the first portion;
a laser head that introduces a laser beam into the column of liquid jetted towards the hole;
a holding member that holds the workpiece; and
a laser beam blocking member that is disposed in the second portion and blocks the laser beam that passes through the hole, wherein
a discharge path that discharges the liquid reaching the hole is provided in the laser beam blocking member.

2. The laser machining device according to claim 1, wherein a cross-sectional area of the discharge path is greater than an exit area of the nozzle.

3. The laser machining device according to claim 1, wherein the holding member is configured to be capable of adjusting an angle of the workpiece and the laser beam blocking member in relation to a jetting direction of the liquid.

4. The laser machining device according to claim 2, wherein the holding member is configured to be capable of adjusting an angle of the workpiece and the laser beam blocking member in relation to a jetting direction of the liquid.

5. The laser machining device according to claim 1, wherein a plurality of holes are to be machined, each hole having circular shape in a cross-section perpendicular to an axial direction of the workpiece.

6. The laser machining device according to claim 1, wherein the workpiece has an open-drum shape in which bottomed-cylindrical shape with bore is formed, a circumference surface being formed in an inside of the bore.

7. A laser machining method for machining a workpiece including a first portion through which a hole is to be machined and a second portion having a surface which should be prevented from being machined, the surface being positioned to be crossed with a longitudinal direction perpendicular to a cross-section of the hole, the hole being machined by using a column of liquid and a laser beam introduced into the column of liquid, wherein:
a laser beam blocking member provided with a discharge path that discharges the liquid reaching the hole is disposed in the second portion, and
the column of liquid is jetted towards the hole of the first portion and the laser beam is introduced into the column of liquid.

8. The laser machining method according to claim 7, wherein the hole is machined into a slit shape by the workpiece and the laser beam blocking member being swung in relation to a jetting direction of the liquid when the column of liquid is jetted from the nozzle and the laser beam is irradiated from the laser head.

9. The laser machining method according to claim 7, wherein a plurality of holes are to be machined, each hole having circular shape in a cross-section perpendicular to an axial direction of the workpiece.

10. The laser machining method according to claim 7, wherein the workpiece has a open-drum shape in which bottomed-cylindrical shape with bore is formed, a circumference surface being formed in an inside of the bore.
